(19) United States
(12) Patent Application Publication
(10) Pub. No.: US 2016/0144978 A1
(43) Pub. Date: May 26, 2016

(54) DRONE EQUIPPED WITH AN IMAGING DEVICE AND WITH MEANS OF PROTECTING THE IMAGING DEVICE

(71) Applicant: AIRNOV, Paris (FR)

(72) Inventor: Corentin CHERON, Paris (FR)

(21) Appl. No.: 14/900,544

(22) PCT Filed: Jun. 20, 2014
(86) PCT No.: PCT/EP2014/063072

§ 371 Date: Dec. 21, 2015

(30) Foreign Application Priority Data
Jun. 21, 2013 (FR) 1355920

(51) Int. Cl. B64D 47/08; G08G 5/04; G05D 1/00; B64C 39/02; G05D 1/10

(52) U.S. Cl. CPC B64D 47/08; B64C 39/024; G05D 1/101; G05D 1/0022; G08G 5/04; B64C 2201/123; B64C 2201/146; B64C 2201/021

(57) ABSTRACT

A device for aerial image capture is provided, preferably for generating agronomic maps, and includes a remote-controlled aerodyne or drone that allows image acquisition. The present aerodyne includes a housing opening onto an exterior surface of the aerodyne via an opening, an imaging device positioned in the housing and arranged in such a way to be able to capture images through the opening, and a closure system including a hatch configured to adopt a closed position in which the opening is closed off, and an open position, in which the opening is uncovered, and an actuating member designed to position the hatch in either the closed or the open position.

### TECHNICAL FIELD

The invention relates to the field of aerial image acquisition. It is used in particular, but not exclusively, for generating agronomic maps. More precisely, the invention relates to a remote-controlled aerodyne comprising an imaging device and means of protecting this imaging device. The invention also relates to a method for controlling this aerodyne.

### PRIOR ART

For a very long time, supplies of water and inputs, such as fertilizers, soil conditioners and plant protection products, have been considered holistically for a given plot of land. For a few years, for economic and environmental reasons, the agricultural community has been seeking to rationalize these supplies, not only globally but also locally, by taking into account the spatial variability of crops. The expression “spatial variability of crops” means that the state of the crops, in particular their water status, their leaf area index, their biomass, their nitrogen nutrition status and their chlorophyll level, can differ between different plots of land, and even between different areas of a plot of land. This spatial variability can be due to different causes of inhomogeneity: the nature and structure of the soil, land relief, residues of the previous crop on the plot of land, supplies of water and fertilizers. Technological progress in agricultural machinery and the development of global positioning systems have made it possible to take into account the spatial variability of crops, with locally adapted supplies. The term “precision agriculture” is commonly used to refer to a method of farming adapting the supplies of water and inputs to the spatial variability of crops.

Precision agriculture of course involves a step of collecting data relating to the state of a crop on the plot of land considered. The data can be collected at different points on the plot of land by taking samples. However, sampling, by definition, does not make it possible to know precisely the state of a crop at every point on the plot of land. The more extensive the plots of land, the more problematic the sampling. Either the resolution of the sampling must be degraded or the period of time necessary for taking samples becomes too restrictive. In practice, the samples are not taken frequently enough to allow water and inputs to be supplied at an early stage.

The development of earth observation satellites for civil purposes has made it possible to respond to the problem of regular data collection over extensive plots of land. However, the resolution of the satellite images can prove inadequate, for example in the case of plots of land having a reduced surface area. In particular, the analysis of test microplots is generally impossible due to the fact that each microplot is covered only by a single pixel of a satellite image. The capture of satellite images also suffers from being dependent on weather conditions, in particular the presence of clouds between the observation satellite and the plots of land to be analyzed.

A first solution for overcoming weather conditions consists of equipping a tractor with sensors making it possible to analyze the state of the crop. Like the taking of samples, this solution can be difficult to implement regularly over extensive plots of land.

Another solution consists of having an imaging device on board an aircraft. Generally, aeroplane-type drones having a maximum mass of a few kilograms are used. The use of a drone equipped with an imaging device makes it possible to acquire, in a few minutes or in a few tens of minutes, images covering areas the surface area of which can vary from less than one hectare to several hundred square kilometres. The cost of one flying hour of a drone can moreover be relatively low. Thus, a plot of land can be analyzed regularly in order to observe the variability of the crop in both space and time.

A drone intended for image acquisition generally comprises a housing making it possible to accommodate the imaging device. This housing is arranged in the fuselage and opens onto the skin of the fuselage via an opening. In order to acquire images of the ground, the opening is made in the lower surface of the fuselage, with the optical elements of the imaging device pointing in the direction of the opening. Due to its layout, in flight, the imaging device is relatively well protected from precipitation in the form of rain and snow, as well as from dust present in the atmosphere. On the other hand, during takeoff and landing of the drone, the imaging device is hit by multiple splashes and flying particles. These can be water, earth, mud, sand or gravel. The imaging device can also knock or rub against the ground or against vegetation. Many drones intended for image acquisition comprise no landing gear. The drones land by bringing their fuselage into contact with the ground. This makes it possible to reduce their mass, but considerably increases splashing, impacts and friction during landing. The imaging device, in particular its optical elements, thus risks being damaged in each landing, and possibly in each takeoff when starting from the ground. As the drone makes approximately twenty flights per day, the imaging device can rapidly cease operating, or can produce degraded images, for example due to the presence of dirt or scratches on an optical element. For this reason, the housing accommodating the imaging device is often enclosed with a protective pane at the opening. The protective pane protects the imaging device from splashing and friction, but is itself soiled and scratched. This results in a loss of quality of the images acquired during subsequent flights; these images may even become useless. The protective pane can be cleaned regularly, or even replaced. However, these operations are tedious and result in a loss of time between flights. Furthermore, the images acquired in flight are generally only used after the drone has landed. Thus, when a flight starts with a dirty or scratched protective pane, the degraded quality of the images is only noticed after the flight, and a new flight must be carried out. Another drawback of the protective pane is that it forms an optical filter for the electromagnetic radiation received by the imaging device. This optical filter attenuates the amplitude of the electromagnetic radiation overall. Furthermore, it most often exhibits variable transmittance as a function of the wavelength of the radiation. If the protective pane is constituted by a relatively inexpensive material, the transmittance can vary greatly, meaning that it has to be characterized with regard to the useful frequency band of the imaging device in order to be able to use the acquired images. This characterization can be avoided by choosing a more optically neutral material, but this generally involves a higher cost for the protective pane.

The use of a protective pane can be avoided by different means. A first means consists of making the imaging device rotationally mobile with respect to the fuselage of the drone. An actuator can position the imaging device so that it points towards the opening of the housing during the flight phases, and towards the inside of the housing during the takeoff and landing phases. However, this means has the drawback of making the mechanical connection to the fuselage of the drone, as well as the electrical connection to the other electronic elements of the drone, more complex.

A second means consists of equipping the drone with a parachute configured to open during landing. The parachute is preferably arranged so that the drone lands on its back. It is then possible to reduce splashing and friction during landing, but not to prevent them completely. Moreover, when the drone is positioned on its back, the imaging device is not protected against precipitation in the form of rain and snow.

A third means for protecting the imaging device is to provide a mechanism with doors or a hatch in order to block the opening of the housing arranged for the imaging device during landing. Document US 2008/267612 A1 describes a camera support which can be mounted on a remote-controlled aircraft. The camera support comprises an extension and retraction mechanism making it possible to reduce drag during flight and to protect the camera. This mechanism can be associated with a door-opening and -closing mechanism. The doors open in order to allow the extension of the camera support, and close again to serve as landing skids.

### DISCLOSURE OF THE INVENTION

A purpose of the invention is in particular to overcome all or some of the abovementioned drawbacks by proposing a drone comprising an imaging device which is protected from the various splashes, impacts and friction during landing, while guaranteeing a consistent quality of the images acquired during flight. To this end, the invention consists of equipping the drone with a removable hatch protecting the imaging device. The hatch can be brought into an open position during flight, for image acquisition, and into a closed position during landing, so as to isolate the imaging device from the outside environment.

More precisely, a subject of the invention is a remote-controlled aerodyne allowing image acquisition. The aerodyne comprises:
a housing opening onto an external surface of the aerodyne via an opening,
an imaging device arranged in the housing and laid out so as to be able to acquire images through the opening, and
a closing system comprising:
   a hatch configured to adopt a closed position, in which it blocks the opening, and an open position, in which it leaves the opening clear, and
   an actuator arranged so as to position the hatch in the closed position or in the open position.

The closed position of the hatch corresponds to a position in which, at the minimum, it enters the field of vision of the imaging device. In the closed position, the hatch can also isolate the housing from the outside environment. The open position of the hatch corresponds to a position in which it does not enter the field of vision of the imaging device.

The housing can be formed in a fuselage of the aerodyne, the opening being formed in an external lower surface of the fuselage. By lower surface is meant the surface of the drone normally facing the ground during a stabilized flight phase. The term “belly of the drone” is also used. The housing could also be formed in another part of the drone, for example in one of the wings of the drone. According to a particular embodiment, the imaging device is firmly fixed in the housing, no extension and retraction mechanism being necessary. The position of the imaging device does not have to be modified when taking photographs. In particular, it can be identical while taking photographs and during landing of the drone.

The closing system can, moreover, comprise connection means forming a slide connection between the housing and the hatch. This type of connection has the advantage of being easy to produce. In particular, it can be produced by a particular arrangement or particular machining of the frame of the housing. It then requires no additional part. The aerodyne can comprise, in addition, a means of propulsion arranged in order to propel the aerodyne in a direction of propulsion. The closing system can then be configured so that the hatch moves from the open position to the closed position in the direction opposite to the direction of propulsion. Thus, any friction of the hatch against the ground during a forward motion of the aerodyne tends to close the hatch or to keep it closed.

According to a particular embodiment, the actuator comprises a servomotor and an arm, the servomotor being capable of driving the arm in rotation with respect to the housing, and the arm being in connection with the hatch so that a rotation of the arm driven by the servomotor is converted to a translational motion of the hatch substantially in the direction of propulsion or in the direction opposite to the direction of propulsion.

Preferably, the lower surface of the aerodyne is configured so as to prevent the aerodyne being able to knock against an obstacle, for example a stone, during landing. The lower surface of the aerodyne can in particular have a continuous surface, or a surface comprising one or more steps where, relative to the direction of propulsion, the downstream surface of each step is recessed with respect to the upstream surface of this step. The expression “recessed surface” must be understood as a surface forming, close to its joint line with the reference surface, a recess or a concavity with respect to this reference surface. In particular, considering that the external surface of the aerodyne comprises an upstream area close to the opening, upstream of the opening relative to the direction of propulsion, the aerodyne can be configured so that, in the closed position, an external surface of the hatch is recessed with respect to the upstream area. Similarly, the external surface of the aerodyne can comprise a downstream area close to the opening, downstream of the opening relative to the direction of propulsion, the aerodyne being configured so that the downstream area is recessed with respect to an external surface of the hatch in the closed position.

According to a particular embodiment, the aerodyne also comprises a seal arranged in order to ensure that the housing is sealed in the closed position of the hatch. The seal can ensure a sealing with respect to solid elements (gravel, dust, etc.), liquids (water, mud, etc.), and/or gases (air).

The aerodyne can also comprise wireless communication means configured for remotely controlling the actuator. The actuator can in particular be controlled by an operator, in particular the operator controlling the aerodyne.

The aerodyne can also comprise a device for determining the altitude or height above ground of the aerodyne and/or a device for detecting obstacles arranged in order to detect obstacles in the path of the aerodyne. The actuator can then be controlled depending on the determined altitude or height above ground, and/or the presence of an obstacle. In the present case, the hatch can be positioned in the closed position below a first predetermined limit altitude and/or if an obstacle is detected, and in the open position above a second predetermined limit altitude and/or in the absence of detection of an obstacle. The actuator can be controlled by a control unit. The device for detecting obstacles or proximity sensor is for example an optical sensor such as an infrared sensor or an ultrasound sensor.

Alternatively or in addition to the wireless communication means, of the device for determining height above ground or altitude, and of the device for detecting obstacles, the aerodyne can comprise a flight management unit configured to control the aerodyne according to a predetermined flight plan, the actuator being controlled according to the predetermined flight plan. In particular, the flight plan can comprise information relating to the times when the hatch must be positioned In the open or closed position.

The invention also relates to a method for controlling a remote-controlled aerodyne as described previously comprising:
a prior to a step of image acquisition by the imaging device, a step of opening the hatch in which the actuator positions the hatch in the open position, and
prior to a landing of the aerodyne, a step of closing the hatch in which the actuator positions the hatch in the closed position.

According to a particular embodiment, outside the image acquisition step, the hatch is positioned in the closed position.

The invention has in particular the advantage of being able to be implemented simply and economically. Another advantage is that the drone can be equipped with any type of imaging device, without having to determine an appropriate material for the transmission of the electromagnetic radiation through the hatch.

### DESCRIPTION OF THE FIGURES

Other advantages and characteristics of the invention will become apparent on reading the detailed description of implementations and embodiments that are in no way limitative, with reference to the attached drawings, in which:

FIG. 1 shows an example of a remote-controlled aerodyne according to the invention;

FIG. 2A shows the remote-controlled aerodyne of FIG. 1 in a partial cross-sectional view, the aerodyne being equipped with an imaging device and a closing system;

FIG. 2B shows, from a first viewpoint, the imaging device and the closing system equipping the remote-controlled aerodyne of FIGS. 1 and 2A;

FIG. 2C shows, from a second viewpoint, the imaging device and the closing system of FIG. 2B;

FIG. 3A shows the closing system of FIGS. 2A, 2B and 2C in an open position;

FIG. 3B shows the closing system of FIGS. 2A, 2B and 2C in a closed position.

### DESCRIPTION OF EMBODIMENTS

As the embodiments described below are in no way limitative, it will be possible in particular to consider variants of the invention comprising only a selection of characteristics described, hereafter in isolation from the other characteristics described (even if this selection is isolated within a sentence containing these other characteristics), if this selection of characteristics is sufficient to confer a technical advantage or to differentiate the invention with respect to the prior art. This selection comprises at least one characteristic, preferably functional, without structural details, or with only a part of the structural details if this part alone is sufficient to confer a technical advantage or to differentiate the invention with respect to the prior art.

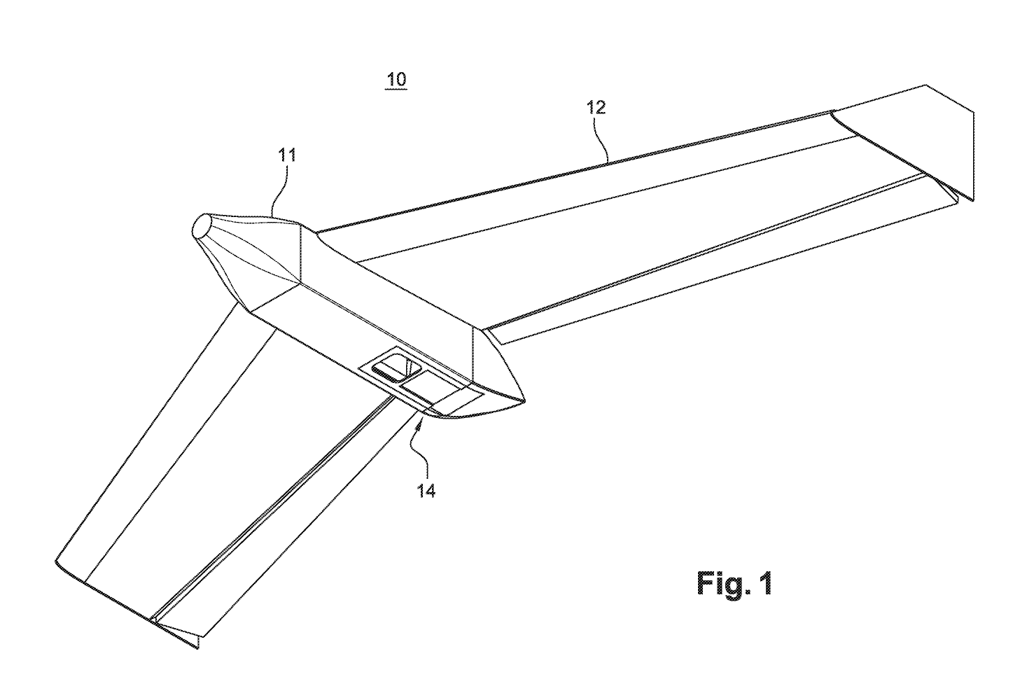

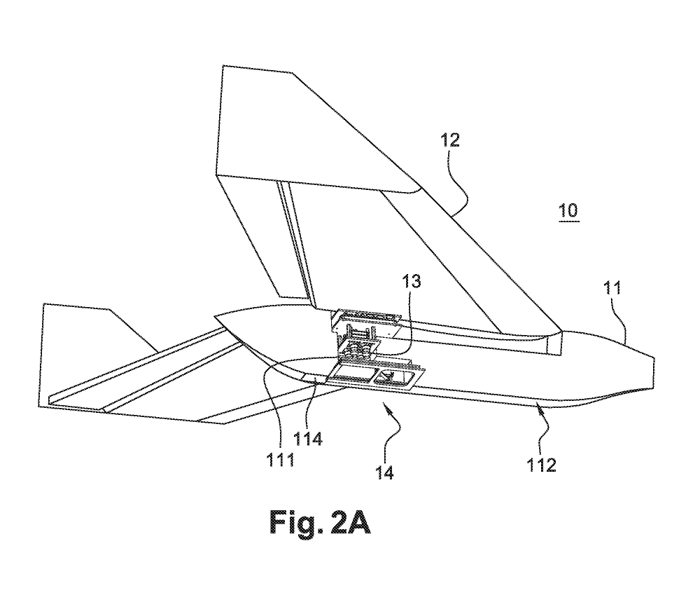

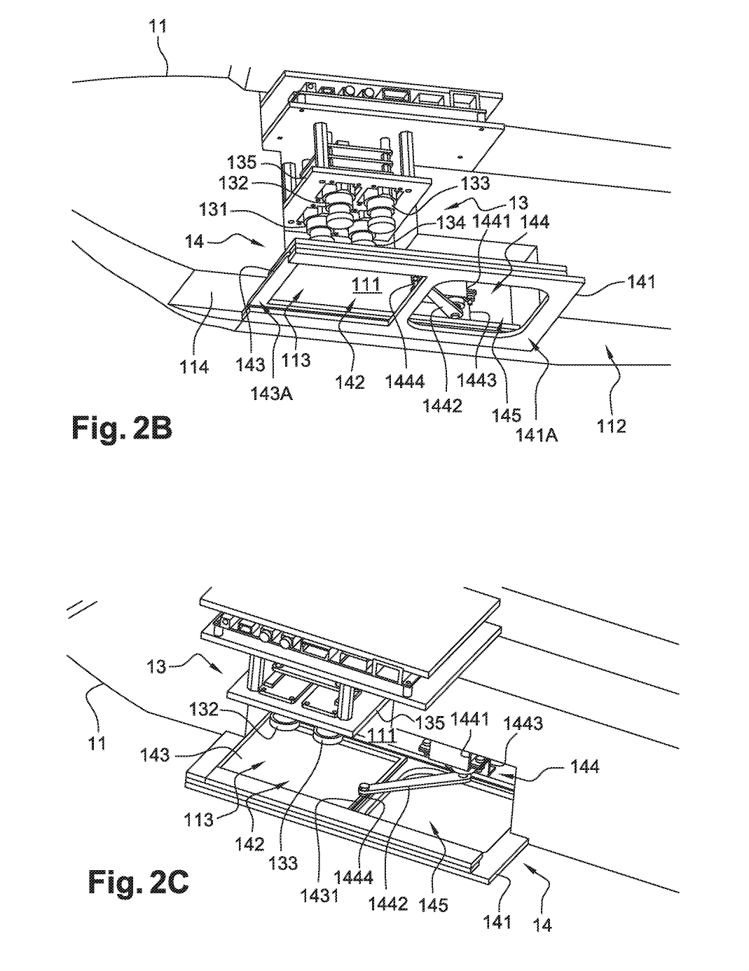

FIG. 1 shows, in a three-quarter view, an example of a remote-controlled aerodyne according to the invention. By “remote-controlled aerodyne” is meant an aerodyne without a pilot on-board, comprising means of propulsion laid out to propel the aerodyne in a direction of propulsion. The aerodyne can be remote-controlled or programmed to follow a pre-established flight plan. It can in particular be an aeroplane-type aerodyne, i.e. a fixed-wing aerodyne driven by an engine. In the remainder of the description, the remote-controlled aerodyne will be denoted by the word “drone”. The drone 10 is intended to acquire aerial images. It comprises in particular a fuselage 11, wings 12, means of propulsion, not shown, and an imaging device 13, visible in FIGS. 2A, 2B and 2C. The drone 10 according to the invention also comprises a closing system 14. The fuselage 11 and the wings 12 of the drone 10 are advantageously formed from one or more low-density materials. By way of example, this can be expanded polystyrene or expanded polypropylene. Preferably, the drone has a total mass less than or equal to 2 kilograms.

FIGS. 2A, 2B and 2C show the drone 10 of FIG. 1 in three-quarter partial cross-sectional views. FIG. 2A shows the whole of the drone 10, and FIGS. 2B and 2C show more precisely, from two different viewpoints, the part of the fuselage 11 accommodating the imaging device 13 and the closing system 14. In these figures, the fuselage 11 of the drone 10 is cut along a longitudinal plane. The drone 10 comprises a housing 111 arranged in the fuselage 11 and opening onto an external surface 112 of the fuselage 11 via an opening 113. The imaging device 13 is laid out so as to allow image acquisition through the opening 113. In the present case, it is laid out in order to be able to take images of the ground during a stabilized flight phase of the drone 10, for example during a straight and level flight. The drone 10 can in particular be used for imaging one or more plots of agricultural land. The opening 113 is then made in the lower external surface of the fuselage 11, i.e. a part of the external surface 112 facing the ground during a stabilized flight phase of the drone 10.

In the example of FIGS. 2A, 2B and 2C, the imaging device 13 comprises four image sensors 131, 132, 133 and 134 mounted on a common support 135. The common support 135 comprises several plates which can each form a printed circuit board. The image sensors 131-134 are laid out with respect to one another so as to cover substantially the same field of vision, i.e. so as to be able to image substantially the same area at a given time. At the very least, the different image sensors 131-134 must cover, at least in part, the same field of vision. The common field of vision is preferably as wide as possible. Of course, the drone 10 can be equipped with an imaging device comprising more or fewer image sensors depending on the number of specific frequency bands that it is desired to image. In the present case, it can comprise only one single image sensor.

Each image sensor 131-134 makes it possible to acquire images in a specific electromagnetic radiation frequency band. The specific frequency bands can cover different parts of the electromagnetic spectrum, in particular in the visible, infrared, near infrared, ultraviolet, and/or X-ray region. They are determined depending on the part or parts of the electromagnetic spectrum that it is desired to observe. The specific frequency bands are in general different from one another, or even separate from one another. A clear dissociation between the specific frequency bands generally allows better characterization of a spectral signature of an observed scene. The image sensors 131-134 are for example digital image sensors each comprising a photosensitive sensor forming a two-dimensional matrix of pixels. Each image is then formed from a set of pixels, generally rectangular in shape, where a pixel represents an average intensity of electromagnetic radiation received in the specific frequency band of the image sensor 131-134 considered. The photosensitive sensor can in particular be of the CCD (Charge-Coupled Device) or CMOS (Complementary Metal-Oxide Semiconductor) type. Image acquisition in a specific frequency band can be achieved by placing an optical filter upstream of the photosensitive sensor. The optical filter can be a bandpass filter, for example an interference filter. This type of filter has the advantage of being able to filter electromagnetic radiation in a relatively narrow frequency band. Other types of filter can also be used, in particular depending on the width of the specific frequency band desired.

According to a particular embodiment, the imaging device 13 is the imaging device from the company VRmagic bearing the reference MFC-12M-4 MCOB M12. This device comprises a USB interface and four heads with the reference VRmMS-12 B/W, produced by the same company. Each of these heads comprises an image sensor produced by the company Aptina and bearing the reference MT9V024.

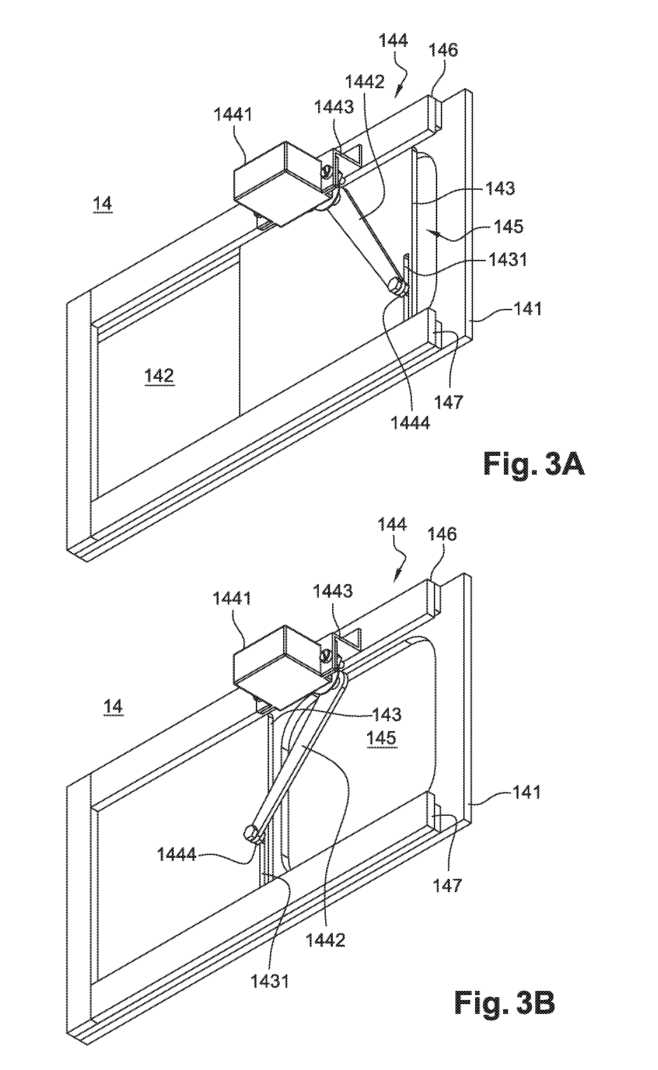

FIGS. 3A and 3B show the closing system 14 in isolation from the remainder of the drone 10. The closing system 14 comprises a frame 141 defining a first opening 142, a hatch 143 and an actuator 144. As shown in FIGS. 2A, 2B and 2C, the closing system 14 is laid out on the fuselage 11 of the drone 10 so that the first opening 142 coincides with the opening 113 of the fuselage 11. The two openings 113 and 142 coincide to the extent that they allow electromagnetic radiation to reach the imaging device 13. Preferably, the openings 113 and 142 are laid out so as to allow electromagnetic radiation to pass over the entire field of vision of all the image sensors 131-134. At the minimum, the openings 113 and 142 are laid out in order to allow the acquisition of the electromagnetic radiation over the field of vision common to all the image sensors 131-134. The shape and dimensions of the openings 113 and 142 can in particular depend on the configuration of the image sensors 131-134. In the present case, the image sensors 131-134 are substantially laid out forming a square, and each image sensor generates substantially rectangular images, the sides of which are parallel to the sides of the square. The openings 113 and 142 thus form a rectangle into which all of the electromagnetic radiation received by one of the image sensors 131-134 can pass. It should be noted that, in practice, each image sensor generally comprises an objective producing a barrel or pincushion distortion of the image observed. The images observed by an image sensor are then not perfectly rectangular. Consequently, the openings 113 and 142 can be adapted, in particular taking into account the barrel or pincushion shapes of the images observed, and/or being enlarged with respect to the dimensions necessary for rectangular images to pass.

The frame 141 can also comprise a second opening 145, as shown in FIGS. 1, 2A, 2B, 2C, 3A and 3B. This second opening 145 is not essential to the invention. It can in particular make it possible to reduce the mass of the frame 141. It can also be used to allow the passage of electromagnetic radiation used by a sensor, or the passage of a sound wave used by an ultrasound sensor, as explained below. The second opening 145 can be blocked by a plate, for example a protective pane made of transparent material. The plate is then preferably laid out so that an external surface of this plate is flush with an external surface 141A of the frame 141.

The actuator 144 makes if possible to bring the hatch 143 into an open position, as shown in FIG. 3A, and into a closed position, as shown in FIGS. 2A, 2B, 2C and 3B. In the open position, the hatch 143 leaves the first opening 142 of the frame 141 clear. In other words, it does not enter the field of vision of the imaging device 13. The hatch 143 is therefore not necessarily made of a material that is transparent for the specific frequency bands of the imaging device 13. In the closed position, the hatch 143 blocks the first opening 142. It thus forms a protective screen for the imaging device 13 against any element external to the drone 10. In particular, it protects the imaging device 13 from all splashes and flying particles. According to a feature of the invention, the hatch 143 can be scratched or soiled, without this interfering with the image acquisition. The actuator 144 comprises for example a servomotor 1441 and an arm 1442. The servomotor 1441 is fixed to the frame 141 of the closing system 14 by means of a fixing bracket 1443. It is capable of driving the arm 1442 in rotation about a first axis. The hatch 143 comprises a groove 1431 extending mainly along a second axis, substantially orthogonal to the first axis. A pin 1444 firmly fixed to the arm 1442 is inserted into the groove 1431. It makes it possible to convert the rotational motion of the arm 142 about the first axis to a translational motion of the hatch 143 along a third axis, orthogonal to the first and to the second axis. The translational motion of the hatch 143 is guided by rails 146 and 147 firmly fixed to the frame 141. Generally, the rails 146, 147 form a slide connection between the hatch 143 and the housing 111 of the fuselage 11. According to a preferred embodiment, the closing system 14 is laid out so that the axis of translation of the hatch 143 (the third axis) is substantially parallel to the direction of propulsion of the drone 10, and so that the movement from the open position to the closed position of the hatch 143 takes place in the direction opposite to the direction of propulsion of the drone 10. This embodiment has the advantage of preventing the hatch 143 from opening by friction against the ground during landing of the drone 10.

Generally, the lower surface of the drone 10 preferably has either a continuous surface or a surface comprising steps where, relative to the direction of propulsion, the downstream surface is recessed with respect to the upstream surface. The expression “recessed surface” must be understood as a surface forming, close to its joint line with the reference surface, a recess or a concavity with respect to this reference surface. More generally, the lower surface of the drone 10 is preferably configured so as to prevent the drone 10 being able to knock against an obstacle, for example a stone, during landing. Such an impact could damage the drone 10, and in particular the imaging device 13.

In the embodiment example shown in FIGS. 2A, 2B and 2C, the external surface 141A of the frame 141 is flush with the external surface 112 of the fuselage 11. Such an incorporation of the closing system 14 into the fuselage 11 prevents the frame 141 knocking against an obstacle. Moreover, it limits the disturbance of the aerodynamic behaviour of the drone 10. The hatch 143 is also laid out so as to avoid forming a catching point on the lower surface of the drone 10, due to a movement of the drone 10 relative to the ground in the direction of propulsion. The area of the external surface of the drone situated close to the opening 113, upstream of this opening 113, is called the “upstream area” and the area of the external surface of the drone situated close to the opening 113, downstream of this opening 113, is called the “downstream area”. In the embodiment shown in FIGS. 2A, 2B and 2C, the upstream area is situated on the frame 141 and the downstream area is situated on the fuselage 11. The upstream area could also be situated on the fuselage 11, and the downstream area on the frame 141. The closing system 14 is laid out so that, in the closed position of the hatch 143, an external surface 143A of the hatch 143 is recessed with respect to the upstream area, and so that the downstream area is recessed with respect to the external surface 143A of the hatch 143. This arrangement can for example be obtained by making a hollow 114 in the fuselage 11 downstream of the opening 113.

According to a particular embodiment, the frame 141 covers all of the opening 113 of the fuselage 11, except for the first opening 142 and, if appropriate, the second opening 145. The imaging device 13 is then better protected from the splashes coming from outside the drone and from friction with the ground. In the case where the frame 141 comprises no second opening 145, the closing system 14 makes it possible to prevent any solid element from penetrating into the housing 111.

For the purpose of better isolating the imaging device 13 from the outside environment, the closing system 14 can comprise a seal laid out in order to ensure a sealing between the housing 111 and the outside environment when the hatch 143 is in the closed position.

The drone 10 also comprises a control unit, not shown, making it possible to control the actuator 144 of the closing system 14. This control unit can be incorporated into a flight management unit making it possible to control the drone 10, or form a device separate from the flight management unit. The control unit can be produced in a purely hardware or purely software form, or by combining a hardware form and a software form. The control unit is configured to control the actuator 144 so that the hatch 143 is positioned in the closed position at least during landing, and in the open position at least during the phases of image acquisition by the imaging device 13.

According to a first variant of the invention, the opening and closing of the hatch 143 are remote-controlled by an operator. The drone 10 then comprises a wireless receiver making it possible to receive instructions relating to the opening and closing of the hatch 143. The wireless receiver can also be used by the operator to control the drone, and/or to trigger image capture during flight. The control unit is connected to the wireless receiver in order to receive the instructions from the operator. Normally the operator must actuate the opening of the hatch 143 before starting image capture and the closing of the hatch 143 before landing.

According to a second variant of the invention, the opening and closing of the hatch 143 are controlled according to a pre-established flight plan. The flight plan can contain all the information allowing the drone 10 to fly over a given area. It can also contain instructions relating to the image capture. It is then particularly suitable for incorporating the instructions relating to the opening and closing of the hatch 143. In this embodiment variant, the control unit can be incorporated into the flight management unit.

According to a third variant of the invention, the opening and closing of the hatch 143 are actuated depending on a height above ground—or optionally an altitude—of the drone 10. Below a first predetermined limit altitude, the actuator 144 can actuate the hatch 143 into the closed position. Above a second predetermined limit altitude, the actuator 144 can actuate the hatch 143 into the open position. The first predetermined limit altitude can be equal to or different from the second limit altitude. The height above ground can in particular be determined by a device incorporated into the drone 10. This is for example an altimeter or a satellite positioning system.

In addition to, or instead of, the different embodiment variants, the drone 10 can comprise a device detecting the presence of obstacles in the path of the drone 10. This can in particular be an ultrasound sensor. The ultrasound sensor is connected to the control unit. When an obstacle is detected, or when it is detected at a distance less than a predetermined limit, the control unit then sends an instruction to close the hatch 143. The device detecting the presence of obstacles can in particular be laid out so as to defect a movement of the drone 10 closer to the ground. It then has the advantage of protecting the imaging device 13 as soon as the drone 10 risks rubbing or knocking against the ground. Of course, the device detecting the presence of obstacles can detect, in addition to the ground, any object located in the path of the drone 10, for example a tree or a utility pole. The imaging device is then protected from unforeseen impacts and friction. The device for detecting obstacles is not necessarily an ultrasound sensor but could also be an optical sensor such as an infrared sensor. The second opening 145 can be used for electromagnetic radiation or a sound wave from the device for detecting obstacles to pass through.

In the embodiment example of FIG. 1, the drone 10 comprises no landing gear. It can nevertheless be equipped therewith.

Of course, the invention is not limited to the examples which have just been described, and numerous adjustments can be made to these examples without exceeding the scope of the invention. In particular, the drone can comprise landing gear. The imaging device can be incorporated into the wings of the drone. The hatch is not necessarily in slide connection with the fuselage of the drone. It can in particular be in swivel connection with the drone. In any case, it must be able to adopt an open position in which it does not enter the field of vision of the imaging device, and a closed position in which it protects the imaging device from the outside environment. Moreover, the different characteristics, forms, variants and embodiments of the invention can be associated with one another in various combinations to the extent that they are not incompatible with one another or mutually exclusive.

1. A remote-controlled aerodyne allowing image acquisition, the aerodyne comprising:
a housing opening onto an external surface of the aerodyne via an opening;
an imaging device arranged in the housing and laid out so as to be able to acquire images through the opening; and
a closing system comprising:
a hatch configured to adopt a closed position, in which it blocks the opening, and an open position, in which it leaves the opening clear; and
an actuator arranged so as to position the hatch in the closed position or in the open position;
the aerodyne further comprising:
a device for detecting obstacles arranged in order to detect obstacles in the path of the aerodyne; and
a control unit configured to control the actuator so that the hatch is positioned in the closed position in the event of an obstacle being detected.

2. A remote-controlled aerodyne allowing image acquisition, the aerodyne comprising:
a housing opening onto an external surface of the aerodyne via an opening;
an imaging device arranged in the housing and laid out so as to be able to acquire images through the opening; and
a closing system comprising:
a hatch configured to adopt a closed position, in which it blocks the opening, and an open position, in which it leaves the opening clear; and
an actuator arranged so as to position the hatch in the closed position or in the open position;
the aerodyne further comprising a flight management unit configured to control the aerodyne according to a predetermined flight plan, the actuator being controlled according to the predetermined flight plan.

3. The aerodyne of claim 1, in which the housing is formed in a fuselage of the aerodyne, the opening being formed in an external lower surface of the fuselage.

4. The aerodyne of claim 1, in which the closing system also comprising connection means forming a slide connection between the housing and the hatch.

5. The aerodyne of claim 4 also comprising a means of propulsion arranged so as to propel the aerodyne in a direction of propulsion, the closing system being configured so that the hatch moves from the open position to the closed position substantially in the direction opposite to the direction of propulsion.

6. The aerodyne of claim 4, in which the actuator comprises a servomotor and an arm, the servomotor being capable of driving the arm in rotation with respect to the housing, the arm being in connection with the hatch so that a rotation of the arm driven by the servomotor is converted to a translational motion of the hatch in the direction of propulsion or in the direction opposite to the direction of propulsion.

7. The aerodyne of claim 1 also comprising a means of propulsion arranged so as to propel the aerodyne in a direction of propulsion, the external surface of the aerodyne comprising an upstream area close to the opening, upstream of the opening relative to the direction of propulsion, the aerodyne being configured so that, in the closed position, an external surface of the hatch is recessed with respect to the upstream area.

8. The aerodyne of claim 1 also comprising a means of propulsion arranged so as to propel the aerodyne in a direction of propulsion, the external surface of the aerodyne comprising a downstream area close to the opening, downstream of the opening relative to the direction of propulsion, the aerodyne being configured so that the downstream area is recessed with respect to an external surface of the hatch in the closed position.

9. The aerodyne of claim 1 also comprising a seal arranged so as to ensure that the housing is sealed in the closed position of the hatch.

10. The aerodyne of claim 1 also comprising wireless communication means configured for remotely controlling the actuator.

11. The aerodyne of claim 1 also comprising a device for determining an altitude or height above ground of the aerodyne, and a control unit configured to control the actuator depending on the determined altitude or height above ground.

12. A method for controlling the remote-controlled aerodyne of claim 1, comprising:
prior to a step of image acquisition by the imaging device, a step of opening the hatch in which the actuator positions the hatch in the open position; and
prior to a landing of the aerodyne, a step of closing the hatch in which the actuator positions the hatch in the closed position.

13. The control method of claim 12, in which, outside the image acquisition step, the hatch is positioned in the closed position.

14. The aerodyne of claim 2, in which the housing is formed in a fuselage of the aerodyne, the opening being formed in an external lower surface of the fuselage.

15. The aerodyne of claim 2, in which the closing system also comprises connection means forming a slide connection between the housing and the hatch.

16. The aerodyne of claim 15 also comprising a means of propulsion arranged so as to propel the aerodyne in a direction of propulsion, the closing system being configured so that the hatch moves from the open position to the closed position substantially in the direction opposite to the direction of propulsion.

17. The aerodyne of claim 15, in which the actuator comprises a servomotor and an arm, the servomotor being capable of driving the arm in rotation with respect to the housing, the arm being in connection with the hatch so that a rotation of the arm driven by the servomotor is converted to a translational motion of the hatch in the direction of propulsion or in the direction opposite to the direction of propulsion.

18. The aerodyne of claim 2 also comprising a means of propulsion arranged so as to propel the aerodyne in a direction of propulsion, the external surface of the aerodyne comprising an upstream area close to the opening, upstream of the opening relative to the direction of propulsion, the aerodyne being configured so that, in the closed position, an external surface of the hatch is recessed with respect to the upstream area.

19. The aerodyne of claim 2 also comprising a means of propulsion arranged so as to propel the aerodyne in a direction of propulsion, the external surface of the aerodyne comprising a downstream area close to the opening, downstream of the opening relative to the direction of propulsion, the aerodyne being configured so that the downstream area is recessed with respect to an external surface of the hatch in the closed position.

20. The aerodyne of claim 2 also comprising a seal arranged so as to ensure that the housing is sealed in the closed position of the hatch;
wireless communication means configured for remotely controlling the actuator; and
a device for determining an altitude or height above ground of the aerodyne, and a control unit configured to control the actuator depending on the determined altitude or height above ground.
